(19) United States
(12) Patent Application Publication
(10) Pub. No.: US 2025/0370308 A1
(43) Pub. Date: Dec. 4, 2025

(54) OPTICAL MODULATOR

(71) Applicant: Sumitomo Electric Industries, Ltd., Osaka (JP)

(72) Inventor: Makoto OGASAWARA, Osaka (JP)

(73) Assignee: Sumitomo Electric Industries, Ltd., Osaka (JP)

(21) Appl. No.: 19/220,221

(22) Filed: May 28, 2025

(30) Foreign Application Priority Data
May 29, 2024 (JP) 2024-086941

(51) Int. Cl. G02F 1/225; G02F 1/21

(52) U.S. Cl. CPC G02F 1/225; G02F 1/212

(57) ABSTRACT

An optical modulator includes a substrate, a first Mach-Zehnder modulator portion including a first semiconductor mesa portion provided on the substrate, a first mesa waveguide provided on the first semiconductor mesa portion, and a second mesa waveguide provided on the first semiconductor mesa portion, a second Mach-Zehnder modulator portion including a second semiconductor mesa portion provided on the substrate, a third mesa waveguide provided on the second semiconductor mesa portion, and a fourth mesa waveguide provided on the second semiconductor mesa portion, at least one protruding portion provided on a bottom surface of a trench formed between the first semiconductor mesa portion and the second semiconductor mesa portion on the substrate, and a resin portion provided in the trench and embedding the at least one protruding portion.

### CROSS REFERENCE TO RELATED APPLICATIONS

This application claims priority based on Japanese Patent Application No. 2024-086941 filed on May 29, 2024, and the entire contents of the Japanese patent application are incorporated herein by reference.

### TECHNICAL FIELD

The present disclosure relates to an optical modulator.

### BACKGROUND

Patent literature (Japanese Unexamined Patent Application Publication No. 2022-37930) discloses a Mach-Zehnder modulator which includes two mesa waveguides provided on a substrate. A resin portion is provided on the substrate to embed the two mesa waveguides.

### SUMMARY

An optical modulator according to one aspect of the present disclosure includes a substrate, a first Mach-Zehnder modulator portion including a first semiconductor mesa portion provided on the substrate, a first mesa waveguide provided on the first semiconductor mesa portion, and a second mesa waveguide provided on the first semiconductor mesa portion, a second Mach-Zehnder modulator portion including a second semiconductor mesa portion provided on the substrate, a third mesa waveguide provided on the second semiconductor mesa portion, and a fourth mesa waveguide provided on the second semiconductor mesa portion, at least one protruding portion provided on a bottom surface of a trench formed between the first semiconductor mesa portion and the second semiconductor mesa portion on the substrate, and a resin portion provided in the trench and embedding the at least one protruding portion.

### BRIEF DESCRIPTION OF THE DRAWINGS

FIG. 1 is a plan view schematically showing an optical modulator according to an embodiment.

FIG. 2 is a cross-sectional view taken along line II-II in FIG. 1.

FIG. 3 is a cross-sectional view taken along line III-III in FIG. 1.

FIG. 4 is a cross-sectional view showing an example of a part of an optical modulator.

FIG. 5 is a cross-sectional view showing another example of a part of an optical modulator.

FIG. 6 is a cross-sectional view schematically showing a part of an optical modulator according to another embodiment.

FIG. 7 is a cross-sectional view schematically showing a part of an optical modulator according to another embodiment.

FIG. 8 is a cross-sectional view schematically showing a part of an optical modulator according to another embodiment.

FIG. 9 is a graph showing an example of a surface position of a resin portion.

FIG. 10 is a cross-sectional view of an optical modulator without a protruding portion, corresponding to FIG. 2.

FIG. 11 is a cross-sectional view of an optical modulator without a protruding portion, corresponding to FIG. 3.

### DETAILED DESCRIPTION

When a plurality of Mach-Zehnder modulator portions is provided on the substrate, a trench is formed on the substrate between the plurality of Mach-Zehnder modulator portions to electrically separate the plurality of Mach-Zehnder modulator portions from each other. When the resin portion is formed in the trench, a depression may be formed in a surface of the resin portion above the trench due to the height difference between a top surface of the mesa waveguide and the bottom surface of the trench.

The present disclosure provides an optical modulator that can improve the surface flatness of a resin portion.

### Description of Embodiments of Present Disclosure

First, embodiments of the present disclosure will be listed and described.
(1) An optical modulator includes a substrate, a first Mach-Zehnder modulator portion including a first semiconductor mesa portion provided on the substrate, a first mesa waveguide provided on the first semiconductor mesa portion, and a second mesa waveguide provided on the first semiconductor mesa portion, a second Mach-Zehnder modulator portion including a second semiconductor mesa portion provided on the substrate, a third mesa waveguide provided on the second semiconductor mesa portion, and a fourth mesa waveguide provided on the second semiconductor mesa portion, at least one protruding portion provided on a bottom surface of a trench formed between the first semiconductor mesa portion and the second semiconductor mesa portion on the substrate, and a resin portion provided in the trench and embedding the at least one protruding portion.

According to the optical modulator, a position of the surface of the resin portion is raised above the trench by the at least one protruding portion. This improves the surface flatness of the resin portion.
(2) In the above (1), the at least one protruding portion may include a plurality of protruding portions. The plurality of protruding portions may be arranged in a two dimensional manner.
(3) In the above (1) or (2), the optical modulator may further include a conductor pattern provided over the resin portion. The conductor pattern may be disposed so as to at least partially overlap the at least one protruding portion when viewed from a direction orthogonal to a main surface of the substrate.
(4) In any one of the above (1) to (3), a height of the at least one protruding portion may be equal to or greater than a height of the first semiconductor mesa portion.
(5) In any one of the above (1) to (4), the at least one protruding portion may include a semiconductor material that is a same as the semiconductor material included in the first semiconductor mesa portion.
(6) In any one of the above (1) to (5), the trench may have a depth of 2 μm or more.
(7) In any one of the above (1) to (6), the resin portion may be a first resin portion. The optical modulator may further include a second resin portion provided over the first resin portion.

### Details of Embodiments of Present Disclosure

Hereinafter, embodiments of the present disclosure will be described in detail with reference to the accompanying drawings. In the description of the drawings, the same or equivalent elements are denoted by the same reference numerals, and redundant description thereof will be omitted. In the drawings, an X-axis direction, a Y-axis direction, and a Z-axis direction which intersect each other are shown as necessary. The X-axis direction, the Y-axis direction, and the Z-axis direction are orthogonal to each other, for example.

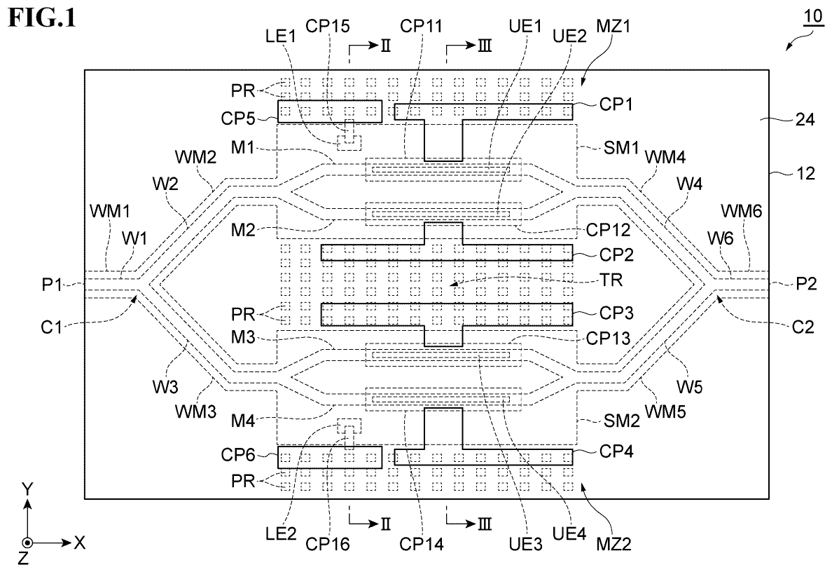

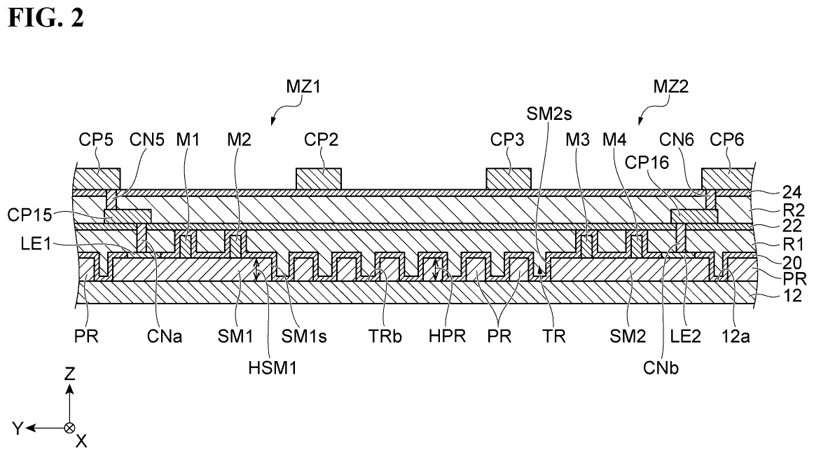

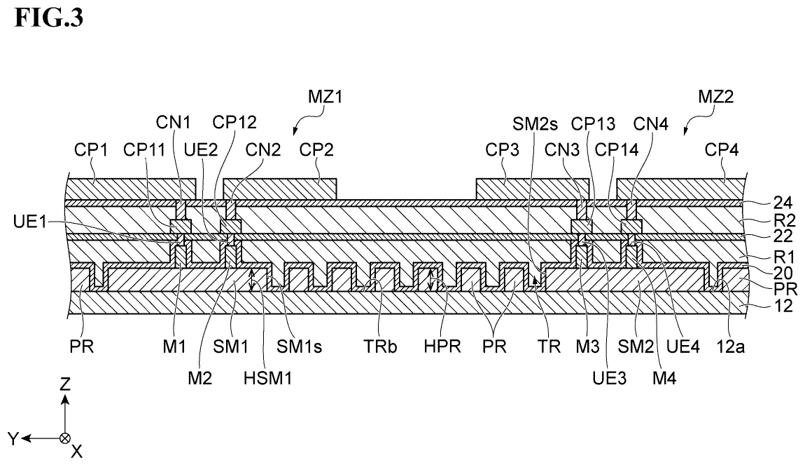

FIG. 1 is a plan view schematically showing an optical modulator according to an embodiment. FIG. 2 is a cross-sectional view taken along line II-II in FIG. 1. FIG. 3 is a cross-sectional view taken along line III-III in FIG. 1. FIGS. 2 and 3 are cross sections each including the Y-axis direction and the Z-axis direction. An optical modulator 10 shown in FIG. 1 is, for example, a Mach-Zehnder modulator. Optical modulator 10 can modulate the intensity or phase of light, for example, in optical communications, and generate a modulated signal. Optical modulator 10 can attenuate light, for example, by adjusting the intensity of light.

Optical modulator 10 includes a substrate 12, a first Mach-Zehnder modulator portion MZ1, and a second Mach-Zehnder modulator portion MZ2. Optical modulator 10 may include three or more Mach-Zehnder modulator portions.

First Mach-Zehnder modulator portion MZ1 includes a first semiconductor mesa portion SM1 provided on substrate 12, a first mesa waveguide M1 provided on first semiconductor mesa portion SM1, and a second mesa waveguide M2 provided on first semiconductor mesa portion SM1. Each of first mesa waveguide M1 and second mesa waveguide M2 extends in the X-axis direction and has height in the Z-axis direction. First mesa waveguide M1 and second mesa waveguide M2 are optically coupled to each other at each of an input end and an output end of first Mach-Zehnder modulator portion MZ1. Second mesa waveguide M2 is spaced apart from first mesa waveguide M1.

Second Mach-Zehnder modulator portion MZ2 includes a second semiconductor mesa portion SM2 provided on substrate 12, a third mesa waveguide M3 provided on second semiconductor mesa portion SM2, and a fourth mesa waveguide M4 provided on second semiconductor mesa portion SM2. Second semiconductor mesa portion SM2 is spaced apart from first semiconductor mesa portion SM1. Each of third mesa waveguide M3 and fourth mesa waveguide M4 extends in the X-axis direction and has height in the Z-axis direction. Third mesa waveguide M3 and fourth mesa waveguide M4 are optically coupled to each other at each of an input end and an output end of second Mach-Zehnder modulator portion MZ2. Fourth mesa waveguide M4 is spaced apart from third mesa waveguide M3.

First mesa waveguide M1 to fourth mesa waveguide M4 are arranged in sequence in the direction opposite to the Y-axis direction. Second mesa waveguide M2 is arranged between first mesa waveguide M1 and third mesa waveguide M3. Third mesa waveguide M3 is arranged between second mesa waveguide M2 and fourth mesa waveguide M4.

Optical modulator 10 may have an input port P1 through which light is input and an output port P2 through which light is output. Input port P1 is located at a first edge of substrate 12. Output port P2 is located at a second edge, which is an opposite side of substrate 12 facing away from the first edge. The first and second edges of substrate 12 extend in the Y-axis direction. Optical modulator 10 may have a phase adjustment portion between first Mach-Zehnder modulator portion MZ1 and output port P2, or may have a phase adjustment portion between second Mach-Zehnder modulator portion MZ2 and output port P2.

An input end of a mesa waveguide W1 is connected to input port P1. Mesa waveguide W1 is provided on a semiconductor mesa portion WM1 provided on substrate 12. An output end of mesa waveguide W1 is optically coupled to an input end of an optical demultiplexer C1. Optical demultiplexer C1 is a multi-mode interference (MMI) coupler, such as a 1×2 multi-mode interference coupler. An input end of a mesa waveguide W2 and an input end of a mesa waveguide W3 are connected to output ends of optical demultiplexer C1. Mesa waveguide W2 is provided on a semiconductor mesa portion WM2 provided on substrate 12. Mesa waveguide W3 is provided on a semiconductor mesa portion WM3 provided on substrate 12. An output end of mesa waveguide W2 is connected to the input end of first Mach-Zehnder modulator portion MZ1. An output end of mesa waveguide W3 is connected to the input end of second Mach-Zehnder modulator portion MZ2.

An input end of a mesa waveguide W4 is connected to the output end of first Mach-Zehnder modulator portion MZ1. Mesa waveguide W4 is provided on a semiconductor mesa portion WM4 provided on substrate 12. An output end of mesa waveguide W4 is optically coupled to an input end of an optical multiplexer C2. Optical multiplexer C2 is a multi-mode interference coupler, such as a 2×1 multi-mode interference coupler. An input end of a mesa waveguide W5 is connected to an output end of second Mach-Zehnder modulator portion MZ2. Mesa waveguide W5 is provided on a semiconductor mesa portion WM5 provided on substrate 12. An output end of mesa waveguide W5 is optically coupled to an input end of optical multiplexer C2. An input end of a mesa waveguide W6 is connected to an output end of optical multiplexer C2. Mesa waveguide W6 is provided on a semiconductor mesa portion WM6 provided on substrate 12. An output end of mesa waveguide W6 is connected to output port P2.

Mesa waveguides W1 to W6 each may have the same semiconductor material and layered structure as first mesa waveguide M1 to fourth mesa waveguide M4. Semiconductor mesa portions WM1 to WM6 each may have the same semiconductor material and layered structure as first semiconductor mesa portion SM1 and second semiconductor mesa portion SM2.

Optical modulator 10 includes at least one protruding portion PR. Optical modulator 10 may include a plurality of protruding portions PR. The plurality of protruding portions PR may be spaced apart from each of first semiconductor mesa portion SM1 and second semiconductor mesa portion SM2. A gap may be provided between adjacent protruding portions PR. The plurality of protruding portions PR may be arranged periodically. The plurality of protruding portions PR may be arranged in a two dimensional manner. The plurality of protruding portions PR may be arranged in a lattice pattern.

A top surface of each protruding portion PR may have a rectangular shape or another shape. An area of the top surface of each protruding portion PR may be 2500 μm² or less. A height HPR of each protruding portion PR may be equal to or greater than a height HSM1 of first semiconductor mesa portion SM1, or equal to or greater than a height of second semiconductor mesa portion SM2. The height HPR of each protruding portion PR is a distance from a main surface 12a of substrate 12 to the top surface of protruding portion PR. Each protruding portion PR may have the same semiconductor material and layered structure as first semiconductor mesa portion SM1 or second semiconductor mesa portion SM2. Protruding portion PR may be formed together with first semiconductor mesa portion SM1 and second semiconductor mesa portion SM2 by photolithography and etching.

The plurality of protruding portions PR is provided on a bottom surface TRb of a trench TR formed between first semiconductor mesa portion SM1 and second semiconductor mesa portion SM2 on substrate 12. Trench TR is defined by a side surface SM1s of first semiconductor mesa portion SM1, a side surface SM2s of second semiconductor mesa portion SM2, and main surface 12a of substrate 12. Side surface SM1s of first semiconductor mesa portion SM1 is a side surface close to second semiconductor mesa portion SM2. Side surface SM2s of second semiconductor mesa portion SM2 is a side surface close to side surface SMls of first semiconductor mesa portion SM1. A depth of trench TR may be 2 μm or more. The depth of trench TR may be the same as height HSM1 of first semiconductor mesa portion SM1 or may be the same as the height of second semiconductor mesa portion SM2.

The plurality of protruding portions PR may be further disposed between first semiconductor mesa portion SM1 and a third edge of substrate 12. In this case, first semiconductor mesa portion SM1 is disposed between the plurality of protruding portions PR and second semiconductor mesa portion SM2. The plurality of protruding portions PR may be further disposed between second semiconductor mesa portion SM2 and a fourth edge of substrate 12. In this case, second semiconductor mesa portion SM2 is disposed between the plurality of protruding portions PR and first semiconductor mesa portion SM1. The third and fourth edges of substrate 12 extend in the X-axis direction.

Optical modulator 10 includes a first resin portion R1 that embeds the plurality of protruding portions PR. First resin portion R1 is provided in trench TR and embeds the plurality of protruding portions PR. First resin portion R1 may embed first semiconductor mesa portion SM1 and second semiconductor mesa portion SM2, or may embed first mesa waveguide M1 to fourth mesa waveguide M4. In the cross sectional view, a surface position of first resin portion R1 may be the same as or lower than top surfaces of first mesa waveguide M1 to fourth mesa waveguide M4. Optical modulator 10 may further include a second resin portion R2 provided over first resin portion R1. Each of first resin portion R1 and second resin portion R2 may include benzocyclobutene (BCB). Each of first resin portion R1 and second resin portion R2 may be formed by applying a resin solution onto substrate 12 by spin coating, and then curing the resin solution. By adjusting the rotation speed of the spin coating, the resin solution remaining on the top surfaces of first mesa waveguide M1 to fourth mesa waveguide M4 can be removed.

An insulating film 20 may be provided between substrate 12 and first resin portion R1. Insulating film 20 covers substrate 12, protruding portions PR, first semiconductor mesa portion SM1, second semiconductor mesa portion SM2, and first mesa waveguide M1 to fourth mesa waveguide M4. An insulating film 22 may be provided between first resin portion R1 and second resin portion R2. An insulating film 24 may be provided on second resin portion R2. Insulating films 20, 22, 24 may be silicon oxynitride (SiON) films.

Optical modulator 10 may include upper electrodes UE1 to UE4 as shown in FIGS. 1 and 3. Upper electrode UE1 is connected to a top surface of first mesa waveguide M1. Upper electrode UE2 is connected to a top surface of second mesa waveguide M2. Upper electrode UE3 is connected to a top surface of third mesa waveguide M3. Upper electrode UE4 is connected to a top surface of fourth mesa waveguide M4. Upper electrodes UE1 to UE4 may extend along first mesa waveguide M1 to fourth mesa waveguide M4, respectively. Upper electrodes UE1 to UE4 may be provided in openings provided in insulating films 20 and 22. Upper electrodes UE1 to UE4 may be laminates including a platinum (Pt) layer, a titanium (Ti) layer, a platinum (Pt) layer, and a gold (Au) layer.

Conductor patterns CP11 to CP14 may be connected to upper electrodes UE1 to UE4, respectively. Conductor patterns CP11 to CP14 are provided on or over first resin portion R1 and insulating film 22, and extend on insulating film 22. Conductor patterns CP11 to CP14 may extend along first mesa waveguide M1 to fourth mesa waveguide M4, respectively. Conductor patterns CP11 to CP14 may be gold (Au) layers.

Connection conductor portions CN1 to CN4 may be connected to conductor patterns CP11 to CP14, respectively. Connection conductor portions CN1 to CN4 extend in second resin portion R2 and insulating film 24 in the Z-axis direction.

Conductor patterns CP1 to CP4 may be connected to connection conductor portions CN1 to CN4, respectively. Conductor patterns CP1 to CP4 are provided over first resin portion R1. Conductor patterns CP1 to CP4 may be provided on or over second resin portion R2 and insulating film 24, and extend on insulating film 24. Conductor patterns CP1 to CP4 each may include a first portion extending along respective first mesa waveguide M1 to fourth mesa waveguide M4, and a second portion connecting each first portion to each of connection conductor portions CN1 to CN4, respectively. Conductor patterns CP1 to CP4 may be gold (Au) layers. Conductor patterns CP1 to CP4 may be disposed so as to at least partially overlap protruding portion PR when viewed from the Z-axis direction (the direction orthogonal to main surface 12a of substrate 12).

Conductor pattern CP1 is connected to upper electrode UE1 by connection conductor portion CN1 and conductor pattern CP11. Conductor pattern CP2 is connected to upper electrode UE2 by connection conductor portion CN2 and conductor pattern CP12. Conductor pattern CP3 is connected to upper electrode UE3 by connection conductor portion CN3 and conductor pattern CP13. Conductor pattern CP4 is connected to upper electrode UE4 by connection conductor portion CN4 and conductor pattern CP14.

Optical modulator 10 may include lower electrodes LE1 and LE2, as shown in FIGS. 1 and 2. Lower electrode LE1 is connected to an upper surface of first semiconductor mesa portion SM1. Lower electrode LE2 is connected to an upper surface of second semiconductor mesa portion SM2. Lower electrodes LE1 and LE2 may be provided in openings provided in insulating film 20. Lower electrodes LE1 and LE2 may be laminates including a gold germanium (AuGe) layer, a nickel (Ni) layer, and a gold (Au) layer.

Connection conductor portions CNa and CNb may be connected to lower electrodes LE1 and LE2, respectively. Connection conductor portions CNa and CNb penetrate first resin portion R1 and insulating film 22 in the Z-axis direction.

Conductor patterns CP15 and CP16 may be connected to connection conductor portions CNa and CNb, respectively. Conductor patterns CP15 and CP16 are provided on or over first resin portion R1 and insulating film 22, and extend on insulating film 22. Conductor patterns CP15 and CP16 are provided between first resin portion R1 and second resin portion R2. Conductor patterns CP15 and CP16 may be gold (Au) layers.

Connection conductor portions CN5 and CN6 may be connected to conductor patterns CP15 and CP16, respectively. Connection conductor portions CN5 and CN6 extend in second resin portion R2 and insulating film 24 in the Z-axis direction.

Conductor patterns CP5 and CP6 may be connected to connection conductor portions CN5 and CN6, respectively. Conductor patterns CP5 and CP6 may be provided on or over second resin portion R2 and insulating film 24, and extend on insulating film 24. Conductor patterns CP5 and CP6 may extend along first mesa waveguide M1 and fourth mesa waveguide M4, respectively. Conductor patterns CP5 and CP6 may be gold (Au) layers. Conductor patterns CP5 and CP6 may be disposed so as to at least partially overlap protruding portion PR when viewed from the Z-axis direction.

Conductor pattern CP5 is connected to lower electrode LE1 by connection conductor portion CN5, conductor pattern CP15 and connection conductor portion CNa. Conductor pattern CP6 is connected to lower electrode LE2 by connection conductor portion CN6, conductor pattern CP16 and connection conductor portion CNb.

The refractive index of first mesa waveguide M1 can be changed by applying a voltage between lower electrode LE1 and upper electrode UE1. The refractive index of second mesa waveguide M2 can be changed by applying a voltage between lower electrode LE1 and upper electrode UE2. The refractive index of third mesa waveguide M3 can be changed by applying a voltage between lower electrode LE2 and upper electrode UE3. The refractive index of fourth mesa waveguide M4 can be changed by applying a voltage between lower electrode LE2 and upper electrode UE4.

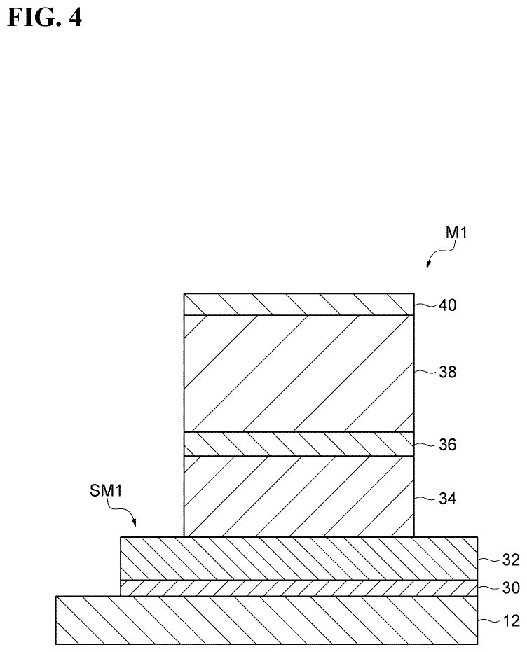

FIG. 4 is a cross-sectional view showing an example of a part of an optical modulator. FIG. 4 is an enlarged view of a part of FIG. 2 or FIG. 3. FIG. 4 shows substrate 12, first semiconductor mesa portion SM1 and first mesa waveguide M1. Second semiconductor mesa portion SM2 may have the same structure as first semiconductor mesa portion SM1. Second mesa waveguide M2 to fourth mesa waveguide M4 may have the same structure as first mesa waveguide M1.

First semiconductor mesa portion SM1 may include a semiconductor layer 30 provided on substrate 12, and a semiconductor layer 32 provided on semiconductor layer 30. First mesa waveguide M1 may include a semiconductor layer 34 provided on semiconductor layer 32, a core layer 36 provided on semiconductor layer 34, a semiconductor layer 38 provided on core layer 36, and a semiconductor layer 40 provided on semiconductor layer 38.

Substrate 12 is, for example, a semi-insulating semiconductor substrate. Substrate 12 includes a III-V compound semiconductor doped with an insulating dopant. Substrate 12 includes, for example, InP doped with iron (Fe). A dopant concentration of substrate 12 may be 1×10¹⁷ cm⁻³ to 1×10¹⁸ cm⁻³.

Semiconductor layer 30 includes a III-V compound semiconductor doped with a p-type dopant. Semiconductor layer 30 includes, for example, InGaAs or InP doped with zinc (Zn). Semiconductor layer 30 has a dopant concentration greater than a dopant concentration of semiconductor layer 32. The dopant concentration of semiconductor layer 30 may be ten or more times as large as the dopant concentration of semiconductor layer 32. The dopant concentration of semiconductor layer 30 may be 5×10¹⁸ cm⁻³ or more, or may be 1×10¹⁹ cm⁻³ or more. A thickness of semiconductor layer 30 is, for example, 0.5 μm to 2.0 μm.

Semiconductor layer 32 includes a III-V compound semiconductor doped with a p-type dopant. Semiconductor layer 32 may include a semiconductor material different from a semiconductor material of semiconductor layer 30. Semiconductor layer 32 includes, for example, InP doped with Zn. The dopant concentration of semiconductor layer 32 may be 5×10¹⁷ cm⁻³ to 2×10¹⁸ cm⁻³. Semiconductor layer 34 may include the same semiconductor material as the semiconductor material of semiconductor layer 32. The total thickness of semiconductor layer 32 and semiconductor layer 34 may be greater than the thickness of semiconductor layer 30, and is, for example, 1.0 μm to 3.0 μm.

Core layer 36 is an i-type semiconductor layer, i.e., a non-doped semiconductor layer. Core layer 36 may have a multiple quantum well structure. Core layer 36 includes, for example, an AlGaInAs-based III-V group compound semiconductor. A width of core layer 36 is, for example, 1.5 μm or less.

Semiconductor layer 38 includes a III-V compound semiconductor doped with an n-type dopant. Semiconductor layer 38 includes, for example, InP doped with Si. A dopant concentration of semiconductor layer 38 may be 5×10¹⁷ cm⁻³ to 2×10¹⁸ cm⁻³. A thickness of semiconductor layer 38 is, for example, 1.0 μm to 3.0 μm.

Semiconductor layer 40 includes a III-V compound semiconductor doped with an n-type dopant. Semiconductor layer 40 may include a semiconductor material different from the semiconductor material of semiconductor layer 38. Semiconductor layer 40 includes, for example, InGaAs or InP doped with Si. Semiconductor layer 40 has a dopant concentration greater than a dopant concentration of semiconductor layer 34. The dopant concentration of semiconductor layer 40 may be 5×10¹⁸ cm⁻³ or more, or 1×10¹⁹ cm⁻³ or more. A thickness of semiconductor layer 40 is, for example, 0.1 μm to 0.5 μm.

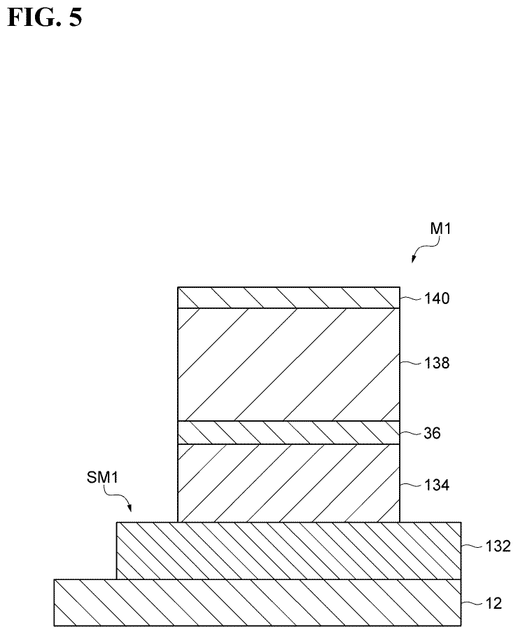

FIG. 5 is a cross-sectional view showing another example of a part of an optical modulator. FIG. 5 is a cross-sectional view corresponding to FIG. 4. Each of substrate 12, first semiconductor mesa portion SM1, and first mesa waveguide M1 may have the structure shown in FIG. 5 instead of the structure shown in FIG. 4. In this structure, first semiconductor mesa portion SM1 includes a semiconductor layer 132 provided on substrate 12. First mesa waveguide M1 includes a semiconductor layer 134 provided on semiconductor layer 132, core layer 36 provided on semiconductor layer 134, a semiconductor layer 138 provided on core layer 36, and a semiconductor layer 140 provided on semiconductor layer 138.

Semiconductor layer 132 and semiconductor layer 134 each include the same semiconductor material as the semiconductor material of semiconductor layer 38 in FIG. 4. Semiconductor layer 132 and semiconductor layer 134 each include, for example, InGaAs or InP doped with Si. Semiconductor layer 138 includes the same semiconductor material as the semiconductor material of semiconductor layer 32 and semiconductor layer 34 in FIG. 4. Semiconductor layer 138 includes, for example, InP doped with Zn. Semiconductor layer 140 includes the same semiconductor material as the semiconductor material of semiconductor layer 30 in FIG. 4. Semiconductor layer 140 includes, for example, InGaAs or InP doped with Zn.

In the optical modulator having the structure shown in FIG. 4, the deeper trench TR may be formed compared to the optical modulator having the structure shown in FIG. 5, resulting in a larger volume of first resin portion R1.

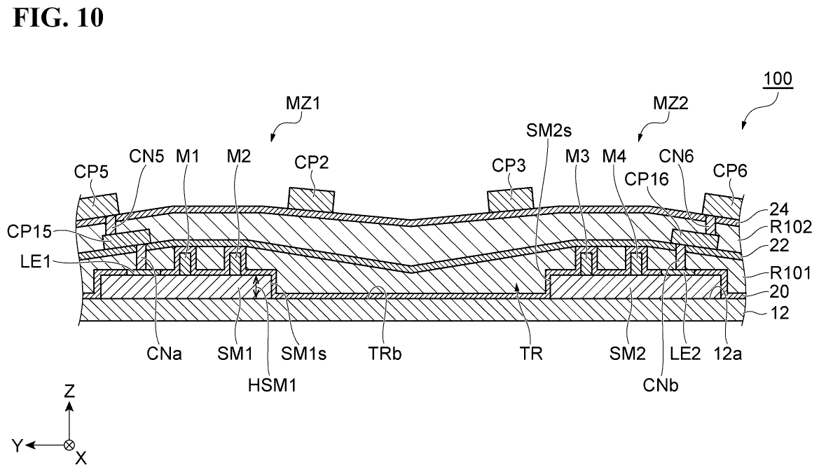

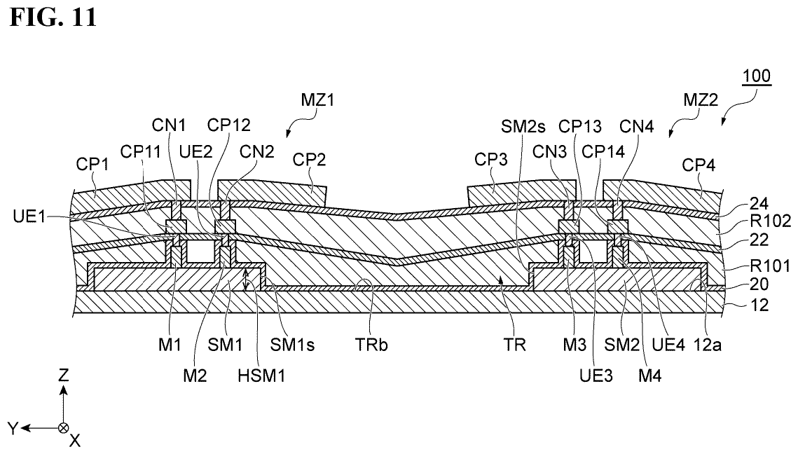

FIG. 10 is a cross-sectional view of an optical modulator without a protruding portion, corresponding to FIG. 2. FIG. 11 is a cross-sectional view of an optical modulator without a protruding portion, corresponding to FIG. 3. As shown in FIGS. 10 and 11, an optical modulator 100 without protruding portion PR includes first resin portion R101 and second resin portion R102. Above trench TR, a deep depression is formed in a surface of each of first resin portion R101 and second resin portion R102. Thus, surface flatness of each of first resin portion R101 and second resin portion R102 is low.

On the other hand, according to optical modulator 10 of the present embodiment, as shown in FIGS. 2 and 3, the position of the surface of first resin portion R1 is raised above trench TR by protruding portions PR. This improves the surface flatness of first resin portion R1. The surface of first resin portion R1 may be flat, or a shallow depression may be formed in the surface of first resin portion R1 above trench TR. Furthermore, the position of a surface of second resin portion R2 is raised above trench TR by protruding portions PR. This improves the surface flatness of second resin portion R2. The surface of second resin portion R2 may be flat, or a shallow depression may be formed in the surface of second resin portion R2 above trench TR.

When the surface flatness of each of first resin portion R1 and second resin portion R2 is improved, for example, it is possible to reduce variations in thickness of each of first resin portion R1 and second resin portion R2 near opening formed in first resin portion R1 and second resin portion R2 by, dry etching. As a result, variation in heights of connection conductor portions CNa, CNb, CN5, and CN6 can be reduced. This can prevent poor connection between lower electrode LE1 and connection conductor portion CNa, poor connection between connection conductor portion CNa and conductor pattern CP15, poor connection between conductor pattern CP15 and connection conductor portion CN5, and poor connection between connection conductor portion CN5 and conductor pattern CP5. Similarly, poor connection between lower electrode LE2 and connection conductor portion CNb, poor connection between connection conductor portion CNb and conductor pattern CP16, poor connection between conductor pattern CP16 and connection conductor portion CN6, and poor connection between connection conductor portion CN6 and conductor pattern CP6 can be prevented.

Furthermore, optical modulator 10 can reduce the volume of first resin portion R1. This can avoid the peeling off of insulating film 20 from the side surfaces of first mesa waveguide M1 to fourth mesa waveguide M4 due to stress from first resin portion R1. When a voltage is applied to each of first mesa waveguide M1 to fourth mesa waveguide M4, a reverse current value through each of first mesa waveguide M1 to fourth mesa waveguide M4 can be reduced.

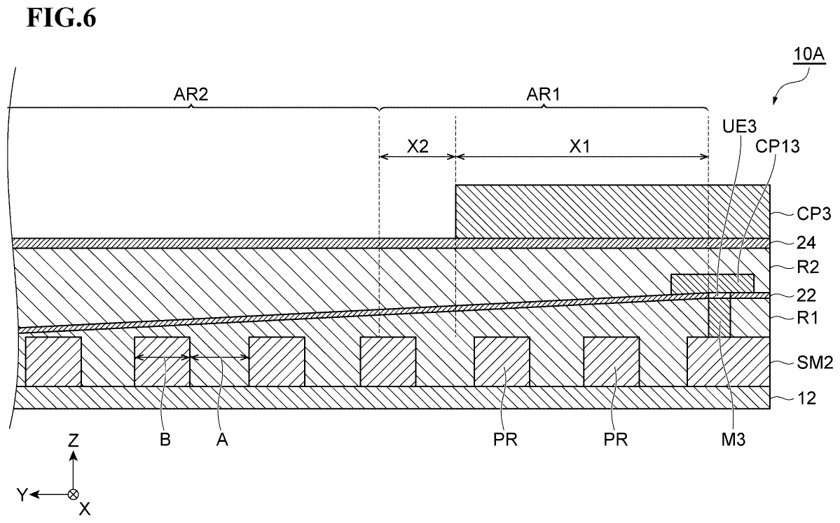

FIG. 6 is a cross-sectional view schematically showing a part of an optical modulator according to another embodiment. An optical modulator 10A shown in FIG. 6 has a model structure corresponding to optical modulator 10 in FIG. 1 to FIG. 3. FIG. 6 is a cross-sectional view corresponding to FIG. 3. As shown in FIG. 6, optical modulator 10A includes a first region AR1 extending from a side surface of third mesa waveguide M3 to a position beyond an end of conductor pattern CP3 in the Y-axis direction (direction orthogonal to the side surface of third mesa waveguide M3), and a second region AR2 farther from the side surface of third mesa waveguide M3 than first region AR1 extends. In the Y-axis direction, a distance from the side surface of third mesa waveguide M3 to the end of conductor pattern CP3 is X1. In the Y-axis direction, the distance from the end of conductor pattern CP3 to an end of first region AR1 is X2. Thus, a length of first region AR1 in the Y-axis direction is equal to X1 plus X2. X1 is, for example, 30 μm to 100 μm. X2 is, for example, 30 μm or more. Optical modulator 10A may include a third region extending from a side surface of second mesa waveguide M2 to a position beyond an end of conductor pattern CP2 in the opposite direction to the Y-axis direction as shown in FIG. 3. The third region is defined in the same manner as first region AR1. Second region AR2 is disposed between the third region and first region AR1.

In optical modulator 10A, protruding portions PR are provided in first region AR1 and second region AR2. Protruding portion PR may be provided in the third region. The filling factor (FF) (%), which represents the filling degree of protruding portion PR, is expressed by the following formula.

$$FF = {B}^{2} / {( A + B )}^{2} \times 100$$

In the formula, A represents the interval between adjacent protruding portions PR in the X-axis direction and the Y-axis direction. B represents the size of protruding portion PR in the X-axis direction and the Y-axis direction. When B is zero, that is, when protruding portion PR is not provided, FF is 0%. When A and B are both 10 μm, FF is 25%. When A is 0 μm, that is, when there is no gap between protruding portions PR, FF is 100%. Both A and B may be more than 0 μm. In first region AR1, B may be 20 μm or less, and FF may be 50% or less. In second region AR2, B may be 0 μm or more, and FF may be 0% to 100%.

In first region AR1, a gap may be provided between adjacent protruding portions PR. In this case, eddy current loss caused by the magnetic field passing through protruding portions PR due to the current flowing through conductor pattern CP3 can be reduced compared to when there is no gap between adjacent protruding portions PR. In second region AR2, a gap may be provided between adjacent protruding portions PR, or it is not necessary that the gap is provided.

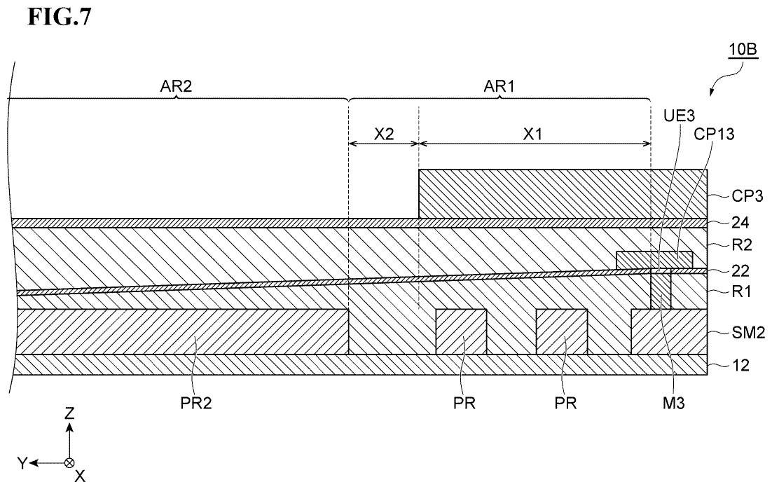

FIG. 7 is a cross-sectional view schematically showing a part of an optical modulator according to another embodiment. FIG. 7 is a cross-sectional view corresponding to FIG. 6. An optical modulator 10B shown in FIG. 7 has the same structure as optical modulator 10A in FIG. 6, except that it includes a terrace portion PR2 instead of protruding portion PR in second region AR2. Terrace portion PR2 is provided on bottom surface TRb of trench TR formed between first semiconductor mesa portion SM1 and second semiconductor mesa portion SM2 on substrate 12. In optical modulator 10B, there is no gap between adjacent protruding portions PR in second region AR2. Terrace portion PR2 has a size larger than that of protruding portion PR in the Y-axis direction. Terrace portion PR2 extends along main surface 12a of substrate 12 in the entire second region AR2. Terrace portion PR2 may have the same semiconductor material and layered structure as first semiconductor mesa portion SM1 and second semiconductor mesa portion SM2. Terrace portion PR2 may be formed together with first semiconductor mesa portion SM1 and second semiconductor mesa portion SM2 by photolithography and etching.

Optical modulator 10B can further improve the surface flatness of first resin portion R1 and second resin portion R2 compared to optical modulator 10A. Furthermore, the volume of first resin portion R1 can be reduced compared to optical modulator 10A, thereby reducing the stress in first resin portion R1.

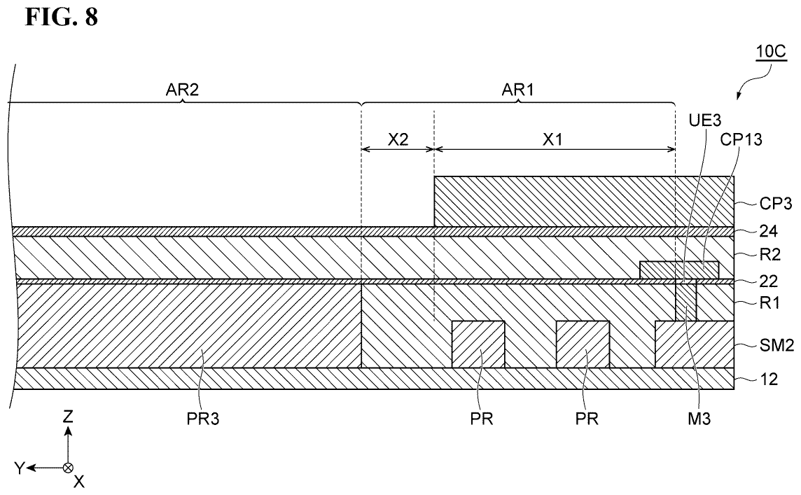

FIG. 8 is a cross-sectional view schematically showing a part of an optical modulator according to another embodiment. FIG. 8 is a cross-sectional view corresponding to FIG. 6. An optical modulator 10C shown in FIG. 8 has the same structure as optical modulator 10B of FIG. 7 except that it includes a terrace portion PR3 instead of terrace portion PR2 in second region AR2. Terrace portion PR3 has the same structure as terrace portion PR2 except that the height is different. The height of terrace portion PR3 is higher than the height of terrace portion PR2. The height of terrace portion PR3 may be the same as the sum of the height of first semiconductor mesa portion SM1 and the height of first mesa waveguide M1, or the same as the sum of the height of first semiconductor mesa portion SM1 and the height of second mesa waveguide M2. The height of terrace portion PR3 may be the same as the sum of the height of second semiconductor mesa portion SM2 and the height of third mesa waveguide M3, or the same as the sum of the height of second semiconductor portion SM2 and the height of fourth mesa waveguide M4. A lower part of terrace portion PR3 may have the same semiconductor material and layered structure as first semiconductor mesa portion SM1 and second semiconductor mesa portion SM2. The lower part of terrace portion PR3 may be formed together with first semiconductor mesa portion SM1 and second semiconductor mesa portion SM2 by photolithography and etching. An upper part of terrace portion PR3 may have the same semiconductor material and layered structure as first mesa waveguide M1 to fourth mesa waveguide M4. The upper part of terrace portion PR3 may be formed together with first mesa waveguide M1 to fourth mesa waveguide M4 by photolithography and etching.

Optical modulator 10C can further improve the surface flatness of each of first resin portion R1 and second resin portion R2 compared to optical modulator 10B. Furthermore, the volume of first resin portion R1 can be reduced compared to optical modulator 10B, thereby reducing the stress in first resin portion R1.

Various experiments conducted to evaluate optical modulators 10, 10A, 10B, and 10C are described below. The experiments described below do not limit the present invention.

### First Experiment

An optical modulator having the same structure as optical modulator 10A in FIG. 6 was fabricated. The plurality of protruding portions PR is periodically arranged in a two dimensional manner in the X-axis direction and the Y-axis direction. An interval A between protruding portions PR and a size B of protruding portion PR are both 10 μm. Each protruding portion PR has a square top surface with a side of 10 μm. Thus, FF is 25%. The height of protruding portion PR is 2.7 μm. The height of each of first semiconductor mesa portion SM1 and second semiconductor mesa portion SM2 is 2.7 μm. The height of each of first mesa waveguide M1 to fourth mesa waveguide M4 is 2.7 μm. In the Y-axis direction, a distance between the side surface of second mesa waveguide M2 and the side surface of first mesa waveguide M1 is 340 μm. First resin portion R1 and second resin portion R2 were formed by applying a BCB solution onto substrate 12 by spin coating and then curing it.

### Second Experiment

An optical modulator was fabricated in the same manner as in the first experiment, except that protruding portion PR was not provided. FF is 0%.

### First Experimental Results

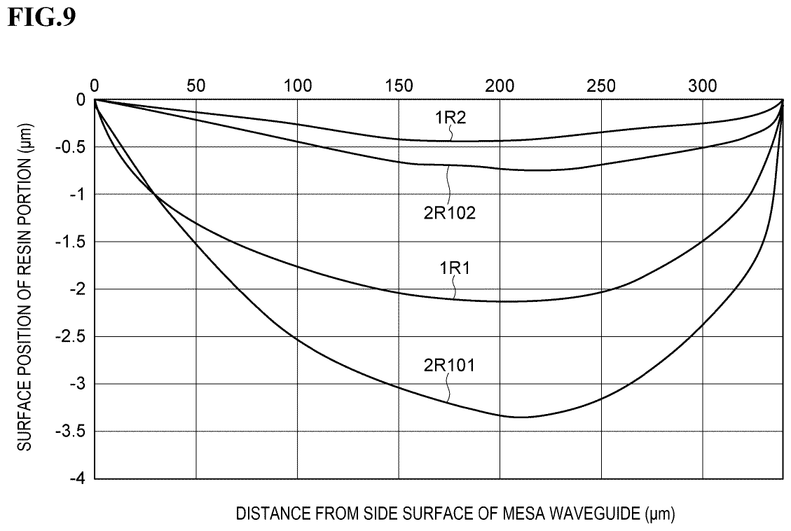

The cross sections of the optical modulators in the first and second experiments corresponding to the cross section in FIG. 6 were observed using a scanning electron microscope (SEM). The surface positions of first resin portion R1 and second resin portion R2 were measured from the SEM images. The measurement results are shown in FIG. 9.

FIG. 9 is a graph showing an example of a surface position of a resin portion. In the graph of FIG. 9, the horizontal axis indicates a distance (μm) from a side surface of a mesa waveguide. The 0 μm on the horizontal axis corresponds to the position of the side surface (side surface close to first mesa waveguide M1) of second mesa waveguide M2 in the Y-axis direction of FIG. 3. The vertical axis indicates a surface position (μm) of the resin portion. The 0 μm on the vertical axis corresponds to the surface position of the resin portion at the highest position. The surface position of the resin portion at the highest position is approximately the same as the positions of the top surfaces of first mesa waveguide M1 and second mesa waveguide M2. In the graph, a solid line 2R101 indicates a surface position of first resin portion R1 in the second experiment. A solid line 2R102 indicates a surface position of second resin portion R2 in the second experiment. A solid line 1R1 indicates the surface position of first resin portion R1 in the first experiment. A solid line 1R2 indicates the surface position of second resin portion R2 in the first experiment.

The difference between solid line 1R1 of first resin portion R1 at the lowest position in the first experiment, and solid line 2R101 of first resin portion R1 at the lowest position in the second experiment, was 1.03 μm. The difference between solid line 1R2 of second resin portion R2 at the lowest position in the first experiment, and solid line 2R102 of second resin portion R2 at the lowest position in the second experiment, was 0.32 μm. Thus, it can be seen that the depth of the depression formed in the surface of the resin portion is shallower in the first experiment compared to the second experiment. Thus, it can be seen that the surface flatness of the resin portion is improved in the first experiment compared to the second experiment.

Although exemplary embodiments of the present invention have been described in detail above, the present invention is not limited to the above embodiments.

The embodiments disclosed herein are to be considered in all respects as illustrative and not restrictive. The scope of the present invention is defined by the appended claims rather than the foregoing description, and is intended to include all modifications within the scope and meaning equivalent to the appended claims.

What is claimed is:

1. An optical modulator comprising:
a substrate;
a first Mach-Zehnder modulator portion including a first semiconductor mesa portion provided on the substrate, a first mesa waveguide provided on the first semiconductor mesa portion, and a second mesa waveguide provided on the first semiconductor mesa portion;
a second Mach-Zehnder modulator portion including a second semiconductor mesa portion provided on the substrate, a third mesa waveguide provided on the second semiconductor mesa portion, and a fourth mesa waveguide provided on the second semiconductor mesa portion;
at least one protruding portion provided on a bottom surface of a trench formed between the first semiconductor mesa portion and the second semiconductor mesa portion on the substrate; and
a resin portion provided in the trench and embedding the at least one protruding portion.

2. The optical modulator according to claim 1,
wherein the at least one protruding portion comprises a plurality of protruding portions, and
wherein the plurality of protruding portions are arranged in a two dimensional manner.

3. The optical modulator according to claim 1, further comprising:
a conductor pattern provided over the resin portion,
wherein the conductor pattern is disposed so as to at least partially overlap the at least one protruding portion when viewed from a direction orthogonal to a main surface of the substrate.

4. The optical modulator according to claim 1,
wherein a height of the at least one protruding portion is equal to or greater than a height of the first semiconductor mesa portion.

5. The optical modulator according to claim 1,
wherein the at least one protruding portion includes a semiconductor material that is a same as the semiconductor material included in the first semiconductor mesa portion.

6. The optical modulator according to claim 1,
wherein the trench has a depth of 2 μm or more.

7. The optical modulator according to claim 1,
wherein the resin portion is a first resin portion, and
wherein the optical modulator further includes a second resin portion provided over the first resin portion.
